(19) United States
(12) Patent Application Publication
(10) Pub. No.: US 2003/0048836 A1
(43) Pub. Date: Mar. 13, 2003

(54) Astute system for detect to adapt to environment

(76) Inventor: Gary Kuan-Hong Hsieh, Taipei (TW)

Correspondence Address: RABIN & CHAMPAGNE, P.C., Suite 500, 1101 14 Street, N.W., Washington, DC, 20005, US

(21) Appl. No.: 10/217,540

(22) Filed: Aug. 14, 2002

(30) Foreign Application Priority Data
Sep. 7, 2001 (TW) 090122290

(51) Int. Cl. H04Q 1/20

(52) U.S. Cl. 375/224

(57) ABSTRACT

An astute system for detect to adapt to environment that can be applied to various detection assemblies. Based on the input detection value of different time, this astute system for detect to adapt to environment works out the reference value and several positive and negative standard deviations out of the reference value as upper limit valve and lower limit valve respectively to execute detection as well as automatically adjusts and updates reference value. This system will output a signal once input detection unit value exceeds the preset valve and its time of appearance exceeds the preset first control time. Meanwhile, when the input detection unit value exceeds the preset second control time and has no qualified relative alteration, this system will totally or partially update the reference value and standard derivation to set new valve to perform detection.

### BACKGROUND OF INVENTION

1. Field of Invention

The present invention relates to a detection system, especially to an astute system for detect to adapt to environment.

2. Description of the Prior Art

Traditional detection system presets an unchangeable control value and can judge only detection value that exceeds the control value as abnormity and output a signal. It cannot adjust the valve according to environmental changes. For example, digital language learning machine executes recording and playing function by automatic detection of sound. Only when there is sound loud enough detected, the learning machine is activated via a sound detection and magnification converter circuit but it cannot adjust control value according to changes of recording environment. Besides, the technology involved in generating frame sound distinguishing in a sound communication system generally speaking comprises the following procedures: (a) first pick up a series of preset parameters, including picking up a tone gain and a tone retardation from each frame input sound signal; and (b) generate a frame sound judgment according to the preset series of parameters, in which the preset series of parameter comprises full frequency band energy and LSF.

Besides, the typical method to detect abnormal pixel in an image censor of prior art, which comprises: download image series from the image sensor; and if in which abnormal pixel exceeds a first valve, this abnormal sensor pixel will be marked. This traditional technology is that when Stuck Low, image picking comprises increasing time of exposure of the sensor and when Stuck High, decreasing time of exposure of the sensor.

### SUMMARY OF THE INVENTION

Different from the astute system for detect to adapt to environment of the present invention that can adjust valve according to environmental changes, the above-mentioned technologies are not so satisfactory when recording environment changes.

The object of the present invention is to provide an astute system for detect to adapt to environment that can adjust detection reference value according to environmental changes and can output a signal when the detection value exceeds the control valve and a preset control time and will adjust and update new reference value and/or valve for control at certain time.

The astute system for detect to adapt to environment of the present invention comprises at least one detection assembly that can connect to a computer device via an analogue to digital converter. The procedures to operate this astute system for detect via computer comprises: pick up signals and input to computer via at lease one of the detection assemblies; each detection assembly adopts multiple picked signals as samples and works out a first reference value and a first standard derivation, according to which sets an upper limit value Lu and a lower limit value Ll to form a banded zone for detection; and preset some values for control which comprises: set a motion unit control value N; set a motion time control value T1 and a second time control value T2; and set a relative comparative constant value K.

If input signal exceeds the banded zone for detection (between the upper limit value Lu and lower limit value Ll), it means intrusion of foreign body into detection zone; besides, if the appearance of said input signal exceeds preset motion time control value T1, it shows the intruder is big enough and worthy of surveillance, which can prevent hypersensitive reaction to meaningless intrusion of foreign bodies such as winged insects. A prefer embodiment is that it also tests whether pixel number of the exceeding unit value is bigger that preset pixel number of motion unit control value N. if it judges intrusion of foreign body is not by accident and worthy of surveillance, it will output a signal. Besides, there is still another procedure for detection and surveillance: when the input value of the detection assembly has neither motion nor qualified relative alteration in a certain period of time T2, it will be sampled as totally or partially new first reference value and form with the first standard derivation a new banded zone for detection.

The astute system for detect to adapt to environment of the present invention can be applied to various detection assemblies, such as singular detection assembly or multiple detection assemblies in array or in matrix, e.g., IR, MIC, CCD, etc. In other words, the detection assembly of the present invention can pick up and input pixel signal via an image detection assembly; or pick up and input audio signal via a voice detection assembly; or execute detection via other detection assemblies such as IR. No matter by which means, detection assembly picks up and inputs digital signal to computer device.

In a preferred embodiment, each detection assembly picks up multiple time-sharing input signals as sample and works out their median as the reference value \overline{x} and standard derivation δ, and then works out several positive and negative δ according to said reference value and adjusts as upper and lower limit valves, e.g., sets \overline{x}+3δ as upper limit valve and \overline{x}−3δ as lower limit valve. Moreover, the present invention can set a second time control value T2 that relates to sampling frequency and therefore makes it possible for above-mentioned reference value \overline{x} and/or standard derivation δ to be automatically amended in the following detection. That is to say, in the successive detection, when input value of the detection assembly has no motion or qualified relative alteration during a certain period of time T2, the present invention will automatically select input detection value as new sample in First-In-First-Out ( FIFO ) mode to replace old sample and work out a new updated reference value \overline{x}A and/or new updated standard derivation δA.

If the successive detection value exceeds valve and preset time and pixel number of the exceeding unit value is bigger than preset pixel number of preset motion unit control value N, this system will judge it as abnormal and output a signal. Moreover, when input detection value of detection assembly has no motion or qualified relative alteration in a certain period of time T2, this system will sample new signal and totally or partly update as new reference value and/or standard derivation to form a new-banded zone for detection to adapt to different environment.

The reference value to judge whether the above-mentioned input value of the detection assembly has qualified alteration comprises: first set a minor unit time and detect the comparative ratio of pixel number of the units ahead of and behind said unit time to judge whether it is bigger than present relative comparative constant K, and accumulate all the unit time no bigger than said constant K. if the accumulated unit time exceeds the second time control value T2, this detect system will judge it as having no qualified relative alteration.

The main function of the present invention is that it can adapt to environmental changes such as changes of background noise or brightness and can automatically amend reference value of detection. The present invention can be applied to: various round-the clock public security digital detection systems, all control systems to be automatically activated via environment signal responding input, e.g., automatic sound recording or video recording devices.

### BRIEF DESCRIPTION OF DRAWINGS

The attached figures illustrate the preferred embodiment of this astute system for detect to adapt to environment.

FIG. 1 is block schematic of the embodiment of the present invention to connect to computer device via single detection unit.

FIG. 2 is flow chart of the embodiment to control via this astute system for detect to adapt to environment.

FIG. 3 is similar to FIG. 1 but illustrates another embodiment to connect via multiple detection assemblies in array.

FIG. 4 is schematic of the meaning to set banded zone for detection based on reference value and standard derivation.

FIG. 5 is similar to FIG. 1 but illustrates another embodiment to connect via multiple detection assemblies in matrix.

FIG. 6 is schematic of the banded zone for detection formed by the upper limit value and lower limit value based on reference value.

FIG. 7 is similar to FIG. 6 but further illustrates time control value T1 and T2.

FIG. 8 is schematic of the alteration of the reference value ^{\overline{x}} according to environmental changes.

### DETAILED DESCRIPTION OF THE PREFERRED EMBODIMENT

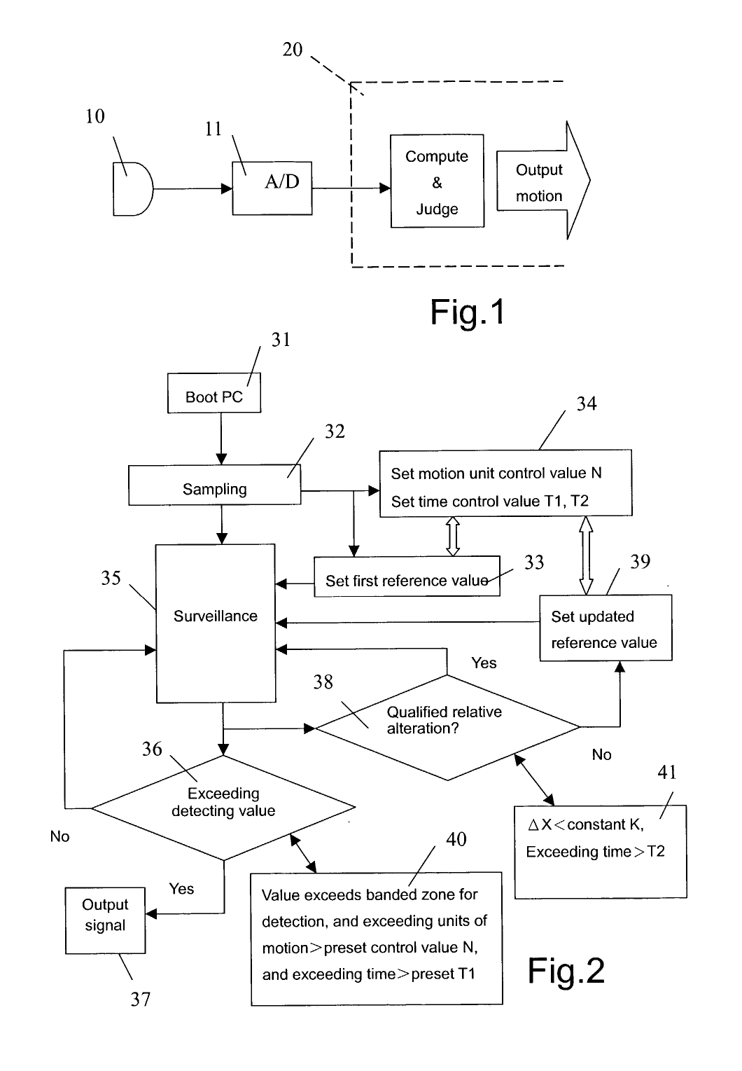

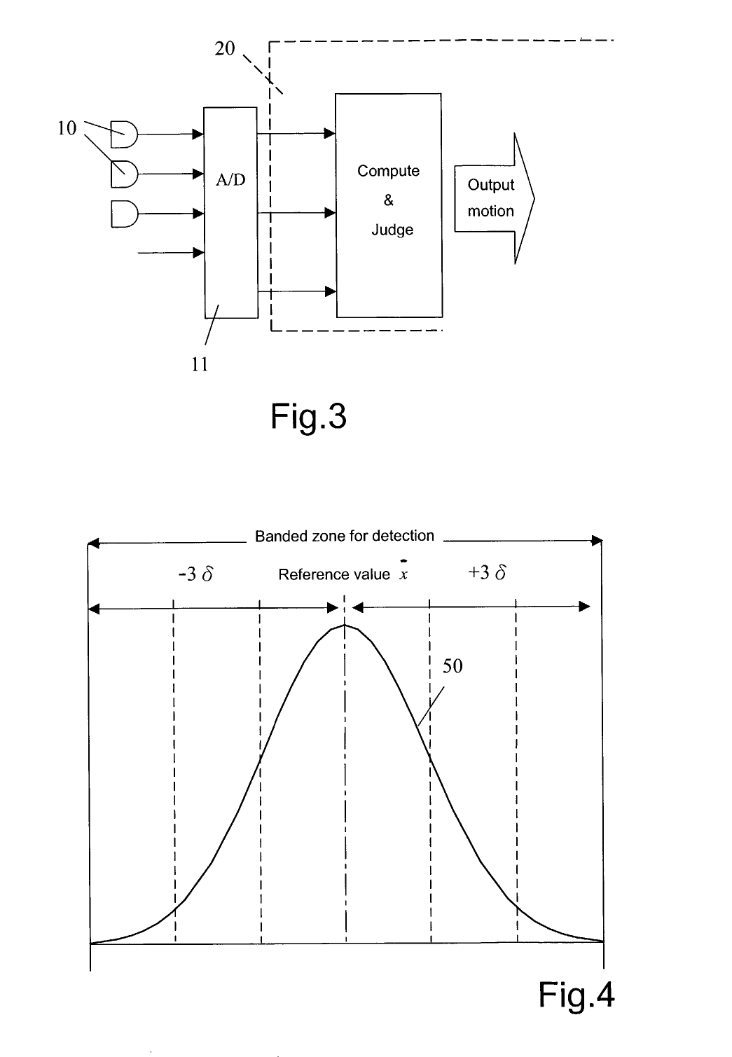

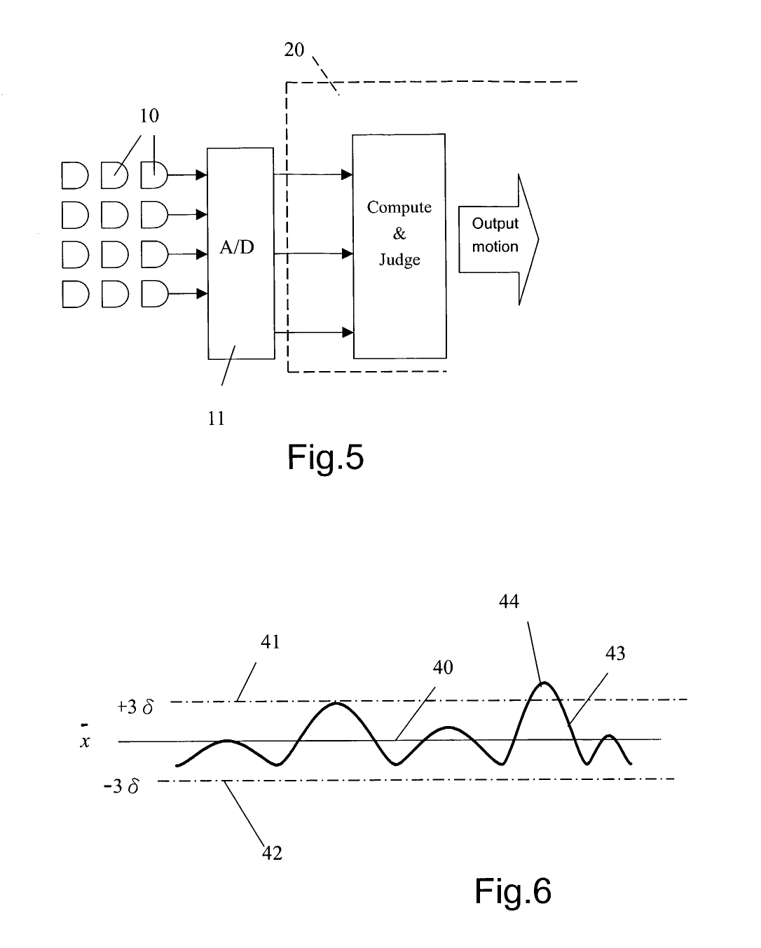

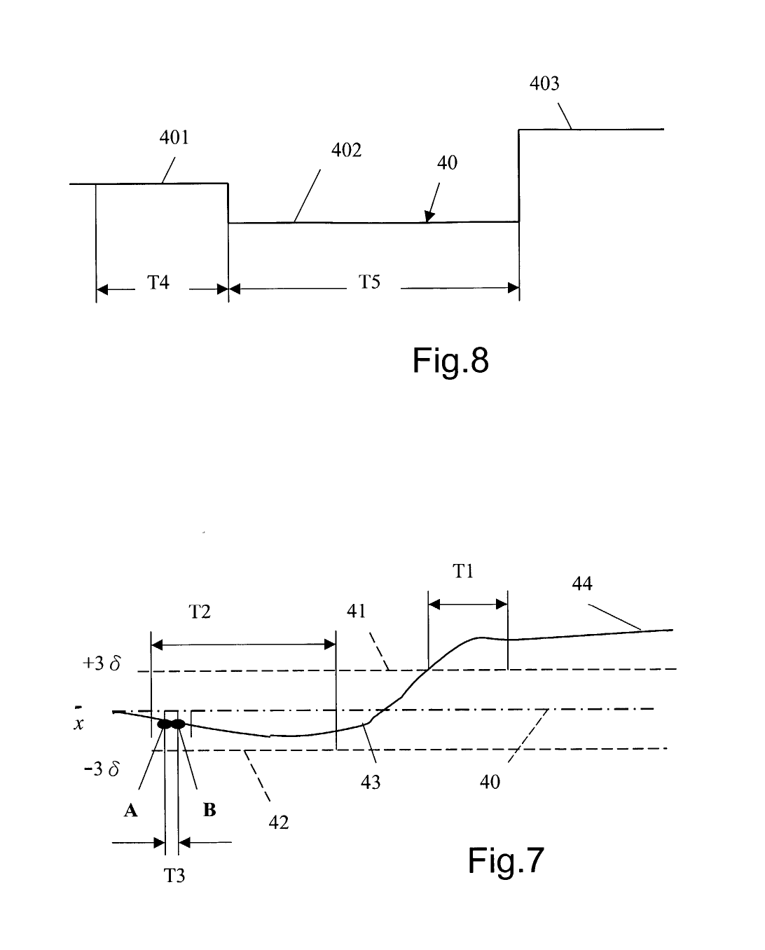

As illustrated in FIG. 1 and please refer to FIG. 3 or FIG. 5, the astute system for detect to adapt to environment of the present invention comprises at least one detection assembly (10) that is connected to a computer device (20). A preferred embodiment of this astute system for detect also comprises an analogue to digital converter (11) that connects to the detection assembly (10) and the computer device (20). FIG. 1 illustrates the embodiment of using a single detection assembly (10); FIG. 3 illustrates the one using multiple detection assemblies in array (10) while FIG. 5 illustrates the one using multiple detection assemblies in matrix (10). The detection assembly (10) can be IR, CCD, etc. in other words, the above-mentioned detection assembly picks up and inputs pixel signal via CCD or audio signal via MIC Anyway, the detection assembly picks up and inputs digital signal to computer and outputs motion signal when necessary upon computer judgment.

As illustrated in FIG. 2, the procedures for detection of the present invention via the computer device (20) comprises: after boot the computer (block 31), as mentioned above, this system picks up and inputs signals via at least one of the detection assemblies (10) and adopts multiple picked signals as sample (block 32) and works out a first reference value (block 33); then as illustrated in FIG. 6, takes said reference value ^{\overline{x}} as median (40) and sets several positive standard derivations δ (+δ) as the upper limit value (41) as well as several negative standard derivations δ (−δ) as the lower limit value (42). A preferred embodiment is that: set ^{\overline{x}}+3δ as upper limit valve and ^{\overline{x}}−3δ as lower limit valve to form a banded zone to detect signal curve (43). Anyway, once the signal curve (44) surpasses the limit of said banded zone for detection, it will be assumed as exceeding. As illustrated in FIG. 4, the banded zone to detect signal curve (43) is formed by reference values ^{\overline{x}}+3δ and ^{\overline{x}}−3δ According to the principle of normal distributing curve (50) in statistics, when the data distribution is bell-shaped, i.e., in symmetrical distribution, 99.7% of the detection value locates within the limit of ^{\overline{x}}−3s, ^{\overline{x}}+3s. in other words, it comprises 99.7% probability for detection.

Please review FIG. 2, the procedures for detection of the present invention via the computer device comprises next: set a motion unit control value N and motion time control value T1, T2 (block 34) and execute surveillance (block 35). While detecting, this system judge whether the detected value exceeds surveillance value (block 36) according to the conditions of block 40 that comprises: when input signal value exceeds said banded zone for detection (L1-L2) as illustrated in FIG. 6 and said input signal motion exceeds preset control value N, meanwhile, the accumulated input time of said input signal exceeds preset time control value T1, this system will judge it as meaningful intrusion of foreign body and output signal (block 36) to execute alarm or other tasks. Therefore, if there is foreign body intruding into detection zone with enough size and enough time, this system will judge it as meaningful intrusion instead of accidental foreign body or noise and further activate surveillance or alarm system; if not, this system will back to block 35 to continue detecting.

On the other hand, a preferred embodiment of the present invention is that: it will check whether there has qualified relative alteration (block 38) according to the conditions of block 40 that comprises: first set a minor unit time T3 and detect the comparative ratio of the pixel number of the unit value B behind said unit time T3 over the pixel number of the unit value A ahead of said unit time T3 to judge whether this ratio is bigger than the preset relative comparative constant K and accumulate the unit time no bigger than said constant K. If the accumulated unit time exceeds the second time control value T2, this system will judge it as having no qualified relative alteration. If there has qualified relative alteration, this system will continue to execute detection (block 35). But if the input value of the detection assembly, as illustrated in FIG. 2, exceeds a certain period of time T2 but has no qualified alteration, this system will sample to totally or partly update the median reference value ^{\overline{x}} in mark 40 into a new updated reference value ^{\overline{x}} (block 38) and according to which, further set new upper/lower limit values to form a new banded zone for detection (block 35). FIG. 4 illustrates the alteration of the reference value (40), e.g., when the background brightness gradually decreases, it will automatically pick up input detection value as new sample in FIFO mode and work out a new updated reference value ^{\overline{x}} A and/or standard derivation δ A based on the original reference value ^{\overline{x}} and/or standard derivation δ. However as illustrated in FIG. 8, e.g. adjusts the reference value (401) to a lower reference value (402) after a certain period of time T4. Of course it can also adjust the reference value to a higher reference value (403) after a certain period of time T5. This system will execute detecting via the updated banded zone to adapt to different environmental background.

The present invention provides an astute system for detects to adapt to environment that can adjust valve according to environmental changes and can output signal once the detection value exceeds said control valve. Besides, the astute system for detect to adapt to environment of the present invention can adjust and update valve according to environmental changes and can further adjust the upper/lower limit value to identify foreign body based on said valve. Therefore, this system can adjust valve and maintain satisfying recording effect despite the environmental changes

What is claimed is as follows:

1. An astute system for detect to adapt to environment, comprising at least one detection assembly to be connected to a computer device; and its procedures to execute detecting via computer device comprising:
(1) Pick up signals and input to computer via at lease one of the above-mentioned detection assemblies;
(2) Each detection assembly adopts multiple picked signals as samples and works out a first reference value \overline{x} and a first standard derivation δ, according to which sets an upper limit value Lu and a lower limit value Ll to form a banded zone for detection;
(3) Set a motion unit control value N;
(4) Set a motion time control value T1 and a second time control value T2;
(5) Set a relative comparative constant value K;
(6) Output a signal if input value of the detection assembly surpasses the banded zone for detection as well as its time of appearance exceeds the preset motion time control value T1; and
(7) Pick up new input signal as sample to totally or partly update the first reference value when input value of the detection assembly has no qualified relative alteration in a certain period of time T2, and together with the above-mentioned first standard derivation to form a new-banded zone for detection.

2. The astute system for detect to adapt to environment of claim 1, further comprising an analogue to digital converter that is connected to said detection assembly and said computer device and that picks up and inputs digital signals to said computer device.

3. The astute system for detect to adapt to environment of claim 1, wherein update of reference value is to work out an updated new reference value ^{\overline{x}}1 and several positive/negative updated new standard derivations δ1 as the updated upper/lower limit valve according to both multiple input detection values and early established original reference value.

4. The astute system for detect to adapt to environment of claim 1, wherein the system works out the median of multiple input signals as said reference value \overline{x} and sets \overline{x}+3δ as upper limit value and \overline{x}−3δ as lower limit value.

5. The astute system for detect to adapt to environment of claim 3, wherein this system automatically replaces original sample with new input detection value in FIFO mode as new sample.

6. The astute system for detect to adapt to environment of claim 1, wherein the yardstick in procedure (6) comprises also to judge whether the pixel number of exceeding unit value is bigger than that of the preset motion unit control value N.

7. The astute system for detect to adapt to environment of claim 1, wherein the yardstick in procedure (7) to judge whether the input value of the detection assembly has qualified relative alteration comprises: first set a minor unit time and check whether the relative ratio of the pixel number of the unit value ahead of and behind said unit time is bigger than the present relative constant K; and accumulate unit time no bigger than constant K; once accumulated unit time exceeds the second time control value T2, it is assumed as having no qualified relative alteration.

8. The astute system for detect to adapt to environment of claim 2, wherein pixel signals are picked up and input via an image detection assembly.

9. The astute system for detect to adapt to environment of claim 2, wherein audio signals are picked up and input via a sound detection assembly.

10. The astute system for detect to adapt to environment of claim 2, wherein digital signals are picked up and input via an IR detection assembly.
